(19) United States
(12) Patent Application Publication
(10) Pub. No.: US 2024/0255379 A1
(43) Pub. Date: Aug. 1, 2024

(54) Apparatus and Method for Monitoring Braking Power

(71) Applicant: Pilz GmbH & Co. KG, Ostfildern (DE)

(72) Inventors: Holger Bode, Ostfildern (DE); Reimund Jaeger, Ostfildern (DE)

(21) Appl. No.: 18/424,788

(22) Filed: Jan. 27, 2024

(30) Foreign Application Priority Data
Jan. 27, 2023 (DE) 102023102076.5

(51) Int. Cl. G01M 13/02; B30B 15/14

(52) U.S. Cl. CPC G01M 13/02; B30B 15/142

(57) ABSTRACT

An apparatus performs braking power monitoring and safety-related locking of a drive of a technical system. The technical system has two machine parts that are movable relative to one another and that are moved towards one another by the drive at a defined actuation interval. A first controller has an input for receiving an encoder signal from an encoder coupled to a drive shaft of the drive. The first controller has an output for outputting an error signal. The first controller determines a value for an acceleration from the encoder signal when a brake coupled to the drive shaft acts with its greatest possible braking force on the drive shaft of the drive and locks the drive in a safety-related manner when the determined value exceeds a limit value stored in the first controller.

### CROSS-REFERENCE TO RELATED APPLICATIONS

This application claims priority to German Application No. 10 2023 102 076.5 filed Jan. 27, 2023, the entire disclosure of which is incorporated by reference.

### FIELD

The present disclosure relates to technical system safety and more particularly to safety-related locking of a technical system based on braking power monitoring.

### BACKGROUND

Technical systems of this type can be machine tools for forming workpieces, such as bending presses, mechanical press brakes, punching machines or cutting machines, in which two machine parts are moved towards each other in order to form a workpiece inserted between the machine parts. It goes without saying that such machines can pose a high risk to the operating personnel, especially if insertion work, i.e. interventions in the tool to insert raw parts or remove finished parts, are carried out manually by the personnel.

Various requirements must therefore be met for the safe operation of technical systems of this type, which are specified in standards by the responsible authorities. For complex technical systems, the requirements of various individual standards usually have to be taken into account in order to ensure comprehensive protection. In Europe, for example, the standard DIN EN ISO 12100 “Safety of machinery”, which contains general design principles for machinery as well as for risk assessment and risk reduction, must always be applied to every machine. For presses, further individual standards must be taken into account that define specific safety requirements, such as the standard DIN EN ISO 16092-2 in the case of eccentric presses. Furthermore, the individual standard DIN EN ISO 13849-1 “Safety-related parts of control systems”, which specifies further, specific requirements for presses in automatic mode, must also be consulted for safe machine control.

One specific safety requirement for presses, for example, is the continuous monitoring of the performance of the brakes (braking power monitoring). During proper operation, a press should stop at the end of a work cycle (actuation interval) at top dead center (OTP), normally a 0° position of a drive shaft, whereby a defined overrun (delayed stop) is permitted, e.g. an overrun of 15°. If the press exceeds the overrun specified in the standard (overrun monitoring), the press must be safely locked.

Due to increases in the performance of modern presses, particularly with regard to the number of strokes per minute, it is not always practicable to measure the overrun or the provisions specified in the standards are not reliable enough to effectively detect an actual deterioration of the brakes.

For example, with some presses, monitoring at the end of each actuation interval is not possible in terms of measurement technology, but only when the press is actually stopped. Furthermore, monitoring is only described in the standard when the press stops in the OTP, but the press can also stop at a location other than the OTP in other operating modes, such as during setup and maintenance.

In addition, due to the high number of cycles of modern presses, electronic camshafts are used instead of classic camshafts, which do not allow overrun monitoring in the manner specified in the standards. Furthermore, at high speeds, values from encoders can only be recorded and processed by very fast controllers (control units) and not, as prescribed, by special safety controllers which, due to their safety features, have a lower processing speed than standard controllers without these features. Known safety devices can therefore not easily be adapted for modern presses.

Controllers for presses are also often configured to adapt a switch-off point of the brake, i.e. a lead angle, to the respective speed. To ensure that a press stops exactly in the OTP, for example, a controller can determine a deviation from the OTP at each stop in the OTP and, based on this, correct the switch-off angle of the brake, i.e. the lead angle, so that the press stops in the OTP again at the next stop. However, the dynamic adjustment of the cut-off angle prevents slow brake wear from being detected via overrun monitoring.

Another problem is that the monitoring procedures described in the DIN EN ISO 16092-2 standard do not take into account the total stopping time of the press, which must be taken into account for determining a safety distance, especially when using an electro-sensitive protective equipment (ESPE), such as a light curtain. However, taking into account the total stopping time of the press would be desirable for a comprehensive safety assessment.

In addition, other conditions can affect the total stopping time, such as the prevailing air pressure, which will affect the time it takes to bleed a brake cylinder and therefore change the total stopping time. These conditions can influence the total stopping time and the associated machine overrun, without these conditions being directly related to the actual braking power (performance) of the brake.

Finally, the maximum overrun angle required by the standard (e.g. 15°) is related to the maximum speed of the press. Lower speeds than the maximum speed result in less overrun for the same wear. As a result, brake wear, which can be critical at high speeds, cannot be detected by overrun monitoring at lower speeds.

### SUMMARY

It is an object to provide an improved apparatus of the aforementioned type which takes into account and avoids the aforementioned problems. It is an object to specify an apparatus of the aforementioned type which enables reliable and uninfluenced monitoring of braking power. Furthermore, it is an object of the present disclosure to provide an apparatus which can reliably ensure safety locking even for machines having a large number of strokes and/or cycles.

According to an aspect of the present disclosure there is provided an apparatus for braking power monitoring and safety-related locking of a drive of a technical system with two machine parts which are movable relative to one another and which are moved towards one another by the drive at a defined actuation interval. The apparatus comprising: a first controller with an input for receiving an encoder signal from an encoder coupled to a drive shaft of the drive and with an output for outputting an error signal, wherein the first controller is configured to determine a value for an acceleration from the encoder signal when a brake coupled to the drive shaft acts on the drive shaft of the drive with the greatest possible braking force, and to lock the drive in a safety-related manner when the determined value exceeds a limit value stored in the first controller.

According to a further aspect of the present disclosure, there is provided a method for braking power monitoring and safety-related locking of a drive of a technical system with two machine parts which are movable relative to one another, and which are moved towards one another by the drive at a defined actuation interval. The method, comprising:
receiving of an encoder signal from an encoder coupled to a drive shaft of the drive at an input of a first controller,
outputting of an error signal at an output of the first controller based on processing of the encoder signal by the first controller,
   wherein the first controller determines a value for an acceleration from the encoder signal when a brake coupled to the drive shaft acts on the drive shaft of the drive with the greatest possible braking force and locks the drive in a safety-related manner when the determined value exceeds a limit value stored in the controller.

It is therefore an idea of the present disclosure to effect safety-related locking of a drive of a technical system, such as a press or a punching machine, by monitoring the actual braking power of a brake (braking power monitoring). This means that a threshold value for locking the drive and/or the machine is not related to an overrun angle, but to a value or function that represents the actual braking power.

The controller can determine the actual braking power by receiving position values (angular positions) from an encoder coupled to the drive shaft of the drive and determining the speed of the drive shaft (velocity) from the position values received via the first derivative and its acceleration via the second derivative. Negative acceleration means that the drive shaft is being decelerated (i.e., braked).

Assuming that a brake acting on the drive shaft acts with the greatest braking force available to it in a defined period of time, the determined (negative) acceleration corresponds directly to the braking power of the brake. In mechanical presses, braking is usually always performed with the maximum possible braking force, since the braking force is determined exclusively by the force of a spring assembly in the brake. In other words, in the case of a mechanical press, the defined period in which the associated brake acts with its maximum braking force corresponds to the period in which a negative acceleration of the drive shaft is measured. Consequently, if the speed of a mechanical press is plotted against time, the braking process is represented as a descending ramp whose negative gradient corresponds to the actual braking power of the brake. Based on the value for the actual braking power, a safety-related locking of the drive can be triggered if the actual braking power falls below a defined value. The trigger for a safety-related locking of the drive can therefore not be an overrun angle, but a minimum braking ramp that is monitored and, if necessary, triggers the locking.

The safety-related locking according to the present disclosure is thus directly linked to the actual braking power and not to a value indirectly derived from the braking power, such as an overrun angle, which can also depend on a variety of other factors. For example, the braking power determined in accordance with the present disclosure is independent of the current air pressure, since the current air pressure is only relevant when the brake is opened (bleeding the brake cylinders) and thus influences the overrun, but not the actual braking power.

With the proposed monitoring of the actual braking power, it is also irrelevant at which point in an actuation interval the brake is applied, as the monitoring is not carried out in relation to a specific location, such as the OTP, but is based solely on the braking process. Monitoring is therefore also possible if the machine is operated in another operating mode that requires a stop at a point other than the OTP, e.g. when setting up or maintaining the machine. According to the proposed monitoring, a safety-related locking can also be triggered in these operating modes if the braking power falls below a certain threshold value. This effectively protects the operating personnel against the possible consequences of reduced braking power even in these special operating modes.

The proposed apparatus for the safety-related locking of a drive thus enables the monitoring of the performance of a brake (braking power monitoring) of the drive as required by the standard and is at the same time more flexible and versatile than other monitoring procedures that are based solely on overrun monitoring.

In a further refinement, the controller can be configured to determine a difference between the determined value for the acceleration and the stored limit value and to output this difference.

According to this refinement, it is possible to set up a wear control for the brake in addition to the locking mechanism. It is conceivable, for example, to store a further threshold value and compare it with the difference determined in order to detect a reduction in braking power and carry out maintenance or replace the brake in good time. As the apparatus determines the actual braking power and not a value derived from it, wear is only indicated if the brake actually no longer has sufficient power. This makes brake maintenance and repair more effective and efficient.

In a further refinement, the first controller can be configured to determine one or more further parameters of the technical system and/or the first controller in order to determine a total stopping time.

According to this refinement, the controller determines at least one further parameter in order to determine a total stopping time. The total stopping time is the time required from the signaling of a stop until the part to be stopped actually comes to a standstill. The total stopping time can be relevant for the dimensioning of electro-sensitive protective equipment. The braking power determined by the device is a factor that can influence the total stopping time. Other parameters that can also be recorded according to the design are, for example, a signal runtime of a stop signal or a switching time of a brake valve. By individually recording the parameters relevant for the total stopping time, a more precise determination of the total stopping time can be made and a more differentiated statement can be made about possible reasons for a longer total stopping time.

In a further refinement, the apparatus can comprise a second controller which can be coupled to the first controller to provide one or more fault detection means in order to carry out fault detection measures.

According to this refinement, the apparatus can therefore have two controllers. The first controller can control the overall process, as well as collect and evaluate the values from the encoder that are relevant to the brake power monitoring. The functionality of the monitoring performed by the first controller can be guaranteed by the second controller. The advantage of splitting the tasks between two controllers is that each controller can be configured for its own task. The first controller can be a fast standard controller (ST controller), for example, which can record one angular position per millisecond from an encoder and process it accordingly. The second controller can be a fail-safe (FS) controller, which operates at a slower processing speed than the first controller, but can have fail-safe features that enable fail-safe processing. The fail-safe features of the second controller can include multi-channel redundant data processing as well as cyclical self-tests or similar. The configuration with two controllers makes it possible to monitor braking power effectively and reliably, even in very fast systems with very short actuation intervals. It is understood that the two controllers can also be configured as one overall controller combined in one housing, with the different tasks being performed by functionally separate units, with at least one first unit corresponding to the first controller being a standard unit and a second unit corresponding to the second controller being a fail-safe-(FS) unit.

The fault detection means of the second (FS) controller may include at least one cyclical test of a limit value detection means of the first controller.

A failure of the limit value detection means, i.e. a failure when comparing the determined value with the stored value and when executing the reaction based on this, must be detected reliably and in a fail-safe manner. This can be achieved by testing the limit value detection means cyclically.

In a further refinement, the second controller can be configured to cyclically send a signal to the first controller, whereupon the first controller changes the stored limit value using a defined calculation rule so that the first controller assumes that the limit value has been exceeded.

According to this refinement, the second controller thus performs a test of a limit value detection means of the first controller by sending a test signal to the first controller at defined intervals and then observing a reaction of the first controller to the test signal. If there is no response, for example, if a defined output of the first controller is not shut down, the second controller can initiate the safety-related locking of the technical system on behalf of the first controller. The first controller can be configured to execute the defined reaction based on the test signal by shifting the stored limit value after receiving the test signal using a calculation, i.e. not by actually replacing the stored value, so that the stored limit value is interpreted as being exceeded, whereupon, for example, an output of the first controller is toggled. The test is carried out cyclically, whereby the distance between the individual tests (test interval) can be greater than the distance between two actuations of the machine parts moving in relation to each other (actuation interval). According to this configuration, the first controller can be effectively tested by a second controller in order to meet the overall requirements of high protection categories, such as e.g. the PLc Cat.2 safety requirement of the EN ISO 13849-1 standard.

In a further refinement, the second controller may be of a multi-channel redundant design, for example, with two mutually redundant processing units providing two independent processing channels.

According to this refinement, the second controller is therefore a safety controller including means for ensuring fail-safe recording, processing and output of control/process data. Such a controller allows for simple and effective fail-safe testing.

In a further refinement, the first controller can be configured to detect at least one angular position of the drive shaft as an encoder signal every millisecond or less.

According to this refinement, the first controller can be a fast controller, for instance a single-channel controller, with a processing unit that can record encoder data (i.e. position data) per millisecond or less. The fast recording and processing of the position data in the specified time range ensures reliable determination of the speed and acceleration with sufficient precision, even for very fast systems with a very short actuation interval. This configuration therefore allows monitoring of the braking power even on very fast systems, such as eccentric presses.

It goes without saying that the features mentioned above and those to be explained below can be used not only in the combination indicated in each case, but also in other combinations or on their own, without leaving the scope of the present invention.

### BRIEF DESCRIPTION OF THE DRAWINGS

Embodiments of the invention are shown in the drawings and are explained in more detail in the following description.

FIG. 1 is a schematic representation of an example of an apparatus for braking power monitoring.

FIG. 2 is a speed-time curve of a braking process.

FIG. 3 is a flowchart of an embodiment of a method for braking power monitoring according to the present disclosure.

### DETAILED DESCRIPTION

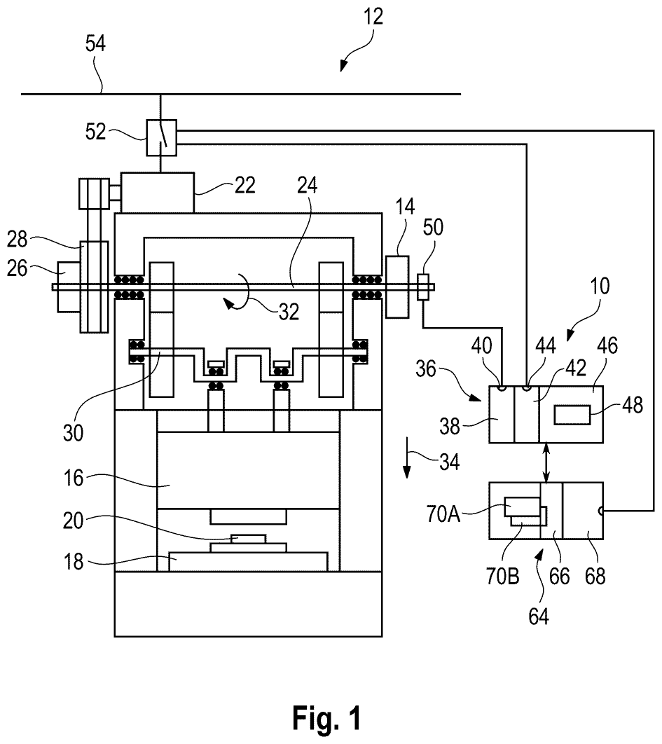

FIG. 1 shows a schematic representation of an embodiment of an apparatus for braking power monitoring according to the present disclosure. The apparatus is designated here in its entirety with the reference number 10.

The apparatus 10 is coupled to a technical system 12 in order to monitor the braking power of a brake 14 of the technical system 12. The technical system 12 can be a forming machine, for instance a press, in which a first machine part 16 and a second machine part 18 are moved towards one another in order to deform a workpiece 20 when the machine parts 16, 18 meet. At least one of the machine parts 16, 18 is set in motion by a drive 22 for this purpose. The drive 22 can be an electric motor which drives a drive shaft 24, for example via a clutch 26 and a flywheel 28. The driven machine part (here the first machine part 16) can be coupled to the drive shaft 24 in such a way that the rotating drive shaft 24 sets the first machine part 16 in a lateral movement with respect to the second machine part 18. For this purpose, the drive shaft 24 can be a crankshaft 30 or an eccentric shaft, depending on the design of the technical system 12, or can be coupled to such a shaft.

A rotational movement 32 of the drive shaft 24 is thus directly related to a lateral movement 34 of the first machine part 16 and thus directly related to an actuation interval of the technical system 12. The actuation interval describes a cycle within which the first machine part 16 moves from an initial position towards the second machine part 18, is brought into engagement with the latter, and returns to the initial position. The initial position is usually the position in which the first machine part 16 is furthest away from the second machine part 18 and is also referred to as top dead center. The top dead center can also define a 0° position of the drive shaft 24.

The drive shaft 24 is also coupled to the brake 14. The brake 14 can decelerate and stop the drive shaft 24. The brake 14 and the clutch 26 may be a brake-clutch combination, although the invention is not limited to such a combination. In various embodiments, the brake 14 can be configured to stop the drive shaft 24 once per actuation interval, for instance at top dead center. In this context, “stop” means to reduce the speed of the drive shaft 24 to zero.

The brake 14 can have a spring assembly which compresses the brake linings (friction pads) when the brake is activated and decelerates the movement of the drive shaft 24 due to the resulting friction. After activating such a brake 14, deceleration takes place with a maximum braking force. It goes without saying that the brake 14 is not limited to this particular configuration and that modifications are conceivable. However, for the purpose of braking power monitoring according to this disclosure, it is relevant that the brake 14 operates at its maximum braking force during a defined monitoring period.

The apparatus 10 has at least a first controller 36 which is coupled to the technical system 12. In the present embodiment, the first controller 36 is a piece of hardware and has a modular design with an input module 38 having an input 40, an output module 42 having an output 44, and a processing module 46 having a processing unit 48. As shown here, the modules can be combined into a single hardware unit that can be installed in a control cabinet. However, the individual modules of the controller 36 can also be distributed in the field in the vicinity of the technical system 12 and connected via a communication channel. In addition to the monitoring described below, the first controller 36 may also perform other control tasks for the technical system 12, which, however, are not described here for the sake of simplicity.

In the embodiment shown here, the first controller 36 is primarily used to monitor a braking power of the brake 14. The input 40 of the input module 38 is connected to an encoder 50, which is arranged on the drive shaft 24 and monitors the rotary movement 32 of the drive shaft 24. The encoder 50 can be a rotary encoder that provides position data of the drive shaft 24 in the form of angular positions and feeds it to the first controller 36 via the input 40. For example, the encoder 50 may determine and provide an angular position every millisecond. The first controller 36 continuously reads in the angular position values, and the processing unit 48 calculates a velocity (1st derivative) and an acceleration (2nd derivative) of the drive shaft 24 from the provided angular position values.

From the determined acceleration, the processing unit 48 deduces a current, actual braking power of the brake 14, as described in more detail below. If the determined braking power falls below a defined threshold value, the processing unit 48 generates an error signal based on which the output 44 can be switched. The output 44 can be coupled to the drive 22 in order to stop the drive when the error signal is present. For example, the output 44 may be connected to a contactor 52 located in a power supply 54 of the drive 22, and the drive 22 receives power from the power supply 54 only when the contactor 52 is turned on by a signal at the output 44. The drive 22 can thus be stopped via the output 44 and the contactor 52 and a restart of the drive 22 can be reliably prevented. The drive 22 is lock in a fail-safe manner when the contactor 52 is de-energized and turned off. It is understood, however, that safety-related locking can be achieved in various other ways.

The processing unit 48 deduces the current braking power of the brake 14 by observing the determined acceleration, for instance, its progression over time, and continuously compares the determined acceleration with a limit value. For example, the processing unit 48 can observe an acceleration over a defined period of time (braking ramp), determine an average value of the acceleration over this period and compare this value with a stored limit value for a minimum allowable braking ramp (gradient). The defined time period is a time period in which the brake 14 decelerates the drive shaft 24 with a maximum braking force. In various embodiments, the defined time period is the time period in which a negative acceleration of the drive shaft can be measured. In other embodiments, the defined time period may be otherwise determined or actively signaled to the processing unit 48 by another device. If the processing unit 48 detects a reduced braking power, it triggers the above-mentioned safety-related locking of the drive 22.

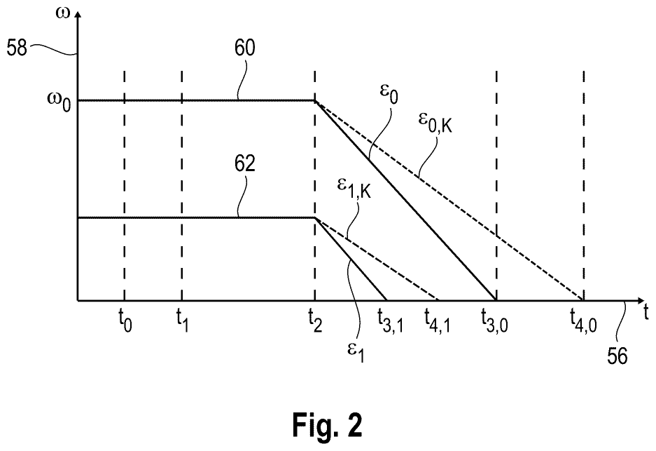

FIG. 2 shows an example of a speed-time curve of a braking process of the technical system 12. The time t is plotted on the abscissa axis 56 and the angular velocity ω is plotted on the ordinate axis 58. In the diagram, a first and a second braking operation are indicated by a first curve and a second curve, respectively. The first curve 60 shows a braking process at a high first output speed ω₀ and the second curve 62 shows a braking process at a second output speed ω₁ that is lower than the first output speed ω₀.

The speeds ω₀ and ω₁ of the drive shaft 24 are initially constant. At a time t₀, the technical system 12 is supplied with a signal to stop the press, whereupon the technical system 12 switches off a valve of the brake 14 with a signal propagation delay at time t1. If the valve has caused the brake to engage, the actual braking process (begins at time t₂. In the case of the first initial speed ω₀, the technical system 12 stops its movement at time t_{3,0}. In the case of the second initial speed ω₁, the technical system 12 stops its movement at time t_{3,1}. The curve of the actual braking process from time t₂ to time t_{3,0} or t_{3,1} describes a braking ramp ε₀ and ε₁, which occur in both cases due to the applied brake 14. Regardless of the initial speed, the respective gradients of the brake ramps ε₀ and ε₁ are identical when using the same brake 14. Only the actual stop times t_{3,0} and t_{3,1} differ for the different speeds.

Assuming that the brake 14 acts with its maximum braking force during the braking process, the gradient of the brake ramps ε₀ and ε₁ corresponds directly to the actual braking power of the brake 14, whereby the braking power is the same in both cases regardless of the initial speed.

The dashed lines also show two braking ramps ε_{0,k} and ε_{1,k} with a lower gradient, which correspond to a critical braking power in each case. If the gradient of a measured braking ramp falls below the gradient of the critical braking ramp, the technical system 12 must be locked until the brake 14 has been serviced or replaced and the brake again shows a braking ramp with a greater gradient. As a result, a value for the gradient of a minimum braking ramp can be used as a safety limit and compared with the actual gradient of a measured braking ramp to trigger the safety-related locking. Thereby, the safety-related locking is directly based on the actual braking power of the brake 14.

As the gradients of the two critical brake ramps ε_{0,k} and ε_{1,k} are identical, safety-related locking will occur in both cases when the brake performance falls below a defined level. Accordingly, even when operating the technical system 12 with a reduced output speed ω₁, a safety-related locking occurs when the braking power is reduced by a certain degree, even if a stopping time (t_{4,1}) at a low output speed ω₁ has not yet exceeded a critical value, as would have been the case at a high output speed ω₀ (t_{4,0}). Therefore, a safety-related locking is correctly linked to the actual braking power and not to a value derived from it, which would possibly lead to a different switch-off behavior.

The monitoring of the braking power according to the proposed procedure is, as with known overrun monitoring systems, a limit value detection, whereby the safety limit value is not based on an overrun angle, but on a minimum braking ramp. Since fail-safe limit value detection cannot be achieved directly by redundant processing of the read angular positions at very high angular velocities, a second controller 64 (FIG. 1) can be provided, which is configured to monitor the limit value detection means of the first controller 36 in a fail-safe manner. For example, the second controller 64 may perform cyclic tests of the limit value detection means of the first controller 36.

The second controller 64 can be a safety controller, which can provide recording, evaluation and output of control and/or process data in a fail-safe manner. The second controller 64 can have two channels with failsafe equipment that allows redundant processing in two separate processing channels, as well as test equipment that continuously synchronizes the two channels. The second controller 64 may perform special tests to verify the functionality of the limit value detection means of the first controller 36.

For such a test, the second controller 64 may be connected to the first controller 36 via an input/output module 66, and the second controller 64 may send a test signal to the first controller 36 which causes the limit value detection means to be “manipulated” in a defined manner by the first controller 36. For example, when the test signal is applied to the first controller 36, the first controller 36 can shift the stored limit value by computation, so that the first controller 36 interprets the stored limit value as if it had been exceeded and acts on an output in response to this. The second controller 64 can be connected to this output and check whether the first controller 36 responds as expected. If the test fails, the second controller 64 can act on the technical system 12 via its own output module 68 on behalf of the first controller 36. In one embodiment, the second controller 64 can use the same devices (contactor 52, etc.) as the first controller 36 for this purpose.

Having two separate controllers 36, 64 has the advantage that the respective controller can be configured for its respective task. For example, the first controller 36 may be equipped with a fast-processing unit 48 that can precisely determine the values essential for monitoring even at high speeds of the technical system 12. The second controller 64 can in turn be configured for the execution of fail-safe tests and for this purpose make use of slower processing units 70A, 70B, which enable parallel and redundant execution and evaluation of the tests. In this way, a fast standard controller does not have to be supplemented with safety-relevant equipment or an existing safety controller does not have to be equipped with faster processing units.

In a further embodiment, the first controller 36 and/or the second controller 64, if present, can determine and monitor further parameters of the technical system 12. The other parameters can be, for example, the signal runtime of a stop signal (in FIG. 2 the time interval between t₀ and t₁) or a switching time of a brake valve (in FIG. 2 the time interval between t₁ and t₂). Based on these values, it is possible to determine a total stopping time. This in turn can be used for further safety-related considerations.

It is also conceivable that the first controller 36 determines a difference between the stored limit value and an actually measured value and makes it available for further processing. Based on the difference, for example, a wear indicator can be realized, e.g. in the form of an indication on a display or in the form of a message to a higher-level control system. The wear indicator can be used to service or replace the brake 14 before the braking power of the brake 14 falls below a safety-critical level and leads to an unexpected stop of the technical system 12.

The proposed apparatus 10 can be used, especially when designed with two controllers, to independently implement standard-compliant braking power monitoring, even for a very high safety category. However, it is also conceivable that the proposed apparatus 10 supplements a previous monitoring system based on overrun monitoring in order to improve monitoring overall.

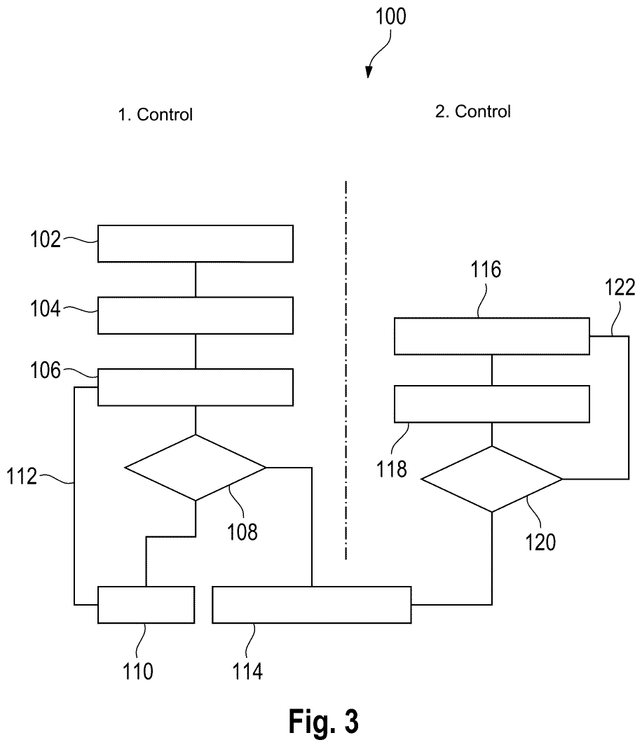

Finally, FIG. 3 shows a flow chart of an embodiment of a method for braking power monitoring according to the present disclosure. The method is designated here in its entirety by the reference numeral 100 and can be carried out on an apparatus 10 as described above.

The method starts with the provision of a first controller with an input for receiving an encoder signal from an encoder coupled to a drive shaft of a drive and with an output for providing an error signal, such as a switch-off signal, for stopping the drive (102).

This is followed by cyclic monitoring of a limit value. To do this, the first controller receives an encoder signal from the encoder, which can be an angular position every millisecond or less (104).

The first controller determines a value for the acceleration of the drive shaft 24 from the continuously recorded angular positions and derives a value for the current braking power from this (106). As explained above, the determined acceleration may directly represent the value of the current braking power.

The first controller then compares the value for the current braking power with a limit value of a minimum braking power (108) stored in the first controller. If the determined braking power is greater than the minimum braking power, the first controller indicates this (110), e.g. using an enable signal, and continues with the comparison of the determined braking power with the minimum braking power (112). If the measured braking power is less than the minimum braking power, the first controller triggers safety-related locking of the technical system 12 (114).

The first controller may output an enable signal in step 110 and inhibit its provision in step 112 to trigger the respective desired response.

In a further embodiment, a continuous test of the limit value detection means of step 108 can be performed in a concurrent process. For this purpose, a second controller can send a test signal to the first controller (116), whereupon the limit value detection means (108) is “manipulated” in a defined manner so that the first controller interprets an exceeding of the limit value. The second controller detects a reaction of the first controller to the test signal (118) and compares this with an expectation (120). If the first controller behaves as expected, the second controller pauses and restarts the test after a defined test interval has elapsed (122). However, if the reaction deviates from an expected reaction, the second controller triggers the safety-related locking of the technical system 12 (114) on behalf of the first controller.

It is understood that the description of the method is only an example and that further steps can be added before, between or at the end of the method described above. It should also be noted that elements of the disclosed apparatus may be implemented by corresponding hardware and/or software elements, e.g. suitable circuits. A circuit is a structural arrangement of electronic components, including conventional circuit elements, integrated circuits, including application-specific integrated circuits, standard integrated circuits, application-specific standard products and field-programmable gate arrays. In addition, a circuit may include central processing units, graphics processing units and microprocessors that are programmed or configured according to a software code. A circuit is not pure software, although a circuit contains the hardware described above, which executes the software.

As used herein, the phrase at least one of A, B, and C should be construed to mean a logical (A OR B OR C), using a non-exclusive logical OR, and should not be construed to mean “at least one of A, at least one of B, and at least one of C.

The above examples are to be understood merely as examples which do not limit the scope of protection. The scope of protection is only defined by the following claims.

1. An apparatus for braking power monitoring and safety-related locking of a drive of a technical system with two machine parts that are movable relative to one another and that are moved towards one another by the drive at a defined actuation interval, the apparatus comprising:
a first controller with an input for receiving an encoder signal from an encoder coupled to a drive shaft of the drive and with an output for outputting an error signal,
wherein the first controller is configured to:
determine a value for an acceleration from the encoder signal in response to a brake coupled to the drive shaft acting with its greatest possible braking force on the drive shaft of the drive, and
lock the drive in a safety-related manner in response to the determined value exceeding a limit value stored in the first controller.

2. The apparatus of claim 1 wherein the first controller is further configured to determine a value for a difference between the determined value for the acceleration and the stored limit value and to output the value for the difference.

3. The apparatus of claim 1 wherein the first controller is configured to determine one or more further parameters of at least one of the technical system and the first controller in order to determine a total stopping time.

4. The apparatus of claim 3 wherein one of the further parameters is a signal propagation time of a stop signal or a switching time of a brake valve.

5. The apparatus of claim 3 wherein one of the further parameters is a switching time of a brake valve.

6. The apparatus of claim 1 further comprising a second controller that is couplable to the first controller to provide one or more fault detectors.

7. The apparatus of claim 6 wherein the one or more fault detectors include at least a cyclic test of a limit value detector of the first controller.

8. The apparatus of claim 7 wherein:
the second controller is configured to cyclically send a signal to the first controller; and
the first controller is configured to, in response to the sent signal, change the stored limit value using a defined calculation rule such that the first controller assumes that the limit value has been exceeded.

9. The apparatus of claim 6 wherein the second controller has a multi-channel, redundant design.

10. The apparatus of claim 1 further comprising two mutually redundant processing units providing two independent processing channels.

11. The apparatus of claim 1 wherein the first controller is configured to detect, every millisecond or less, at least one angular position of the drive shaft as an encoder signal.

12. The apparatus of claim 1 wherein the first controller is a standard controller that processes the encoder signal in a single-channel manner.

13. The apparatus of claim 1 wherein the safety-related locking of the drive of the technical system includes switching off the drive.

14. The apparatus of claim 1 wherein the error signal is a switch-off signal for stopping the drive.

15. A method for braking power monitoring and safety-related locking, of a drive of a technical system with two machine parts that are movable relative to one another and that are moved towards one another by the drive at a defined actuation interval, the method comprising:
receiving of an encoder signal from an encoder coupled to a drive shaft of the drive at an input of a first controller; and
outputting of an error signal at an output of the first controller based on processing of the encoder signal by the first controller,
wherein the first controller determines a value for an acceleration from the encoder signal in response to a brake coupled to the drive shaft acting with its greatest possible braking force on the drive shaft of the drive and locks the drive in a safety-related manner in response to the determined value exceeding a limit value stored in the first controller.

16. The method of claim 15 further comprising determining a value for a difference between the determined value for the acceleration and the stored limit value and to outputting the value for the difference.

17. The method of claim 15 further comprising determining one or more further parameters of at least one of the technical system and the first controller in order to determine a total stopping time.

18. The method of claim 15 further comprising providing one or more fault detectors by a second controller that is couplable to the first controller.

19. The method of claim 18 wherein the one or more fault detectors include at least a cyclic test of a limit value detector of the first controller.

20. The method of claim 19 further comprising:
cyclically sending, by the second controller, a signal to the first controller; and
in response to the sent signal, changing, by the first controller, the stored limit value using a defined calculation rule such that the first controller assumes that the limit value has been exceeded.
